(19) United States
(12) Patent Application Publication
(10) Pub. No.: US 2004/0010574 A1
(43) Pub. Date: Jan. 15, 2004

(54) System and method for automatically configuring and launching telnet 3270 client applications in a windows environment

(76) Inventors: Michael Cammick, Tampa, FL (US); Didier F. Giroir, Cagnes sur Mer (FR); Olivier Hericourt, Cagnes sur Mer (FR)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/194,288

(22) Filed: Jul. 15, 2002

(51) Int. Cl. G06F 15/16

(52) U.S. Cl. 709/222; 709/228

(57) ABSTRACT

A system and method for automatically configuring and launching Telnet “TN” 3270 client applications on a workstation operating in a Windows environment includes a Web application navigator located remotely from the workstation and an SNA application navigator installed on the workstation. The Web application navigator accessed via a Web browser provides session configuration information associated with various SNA target applications to the workstation. When a user selects one of the SNA target applications, the Web application navigator sends session configuration information to the workstation. This session configuration information includes a location and/or an identity of a TN3270 server associated with the SNA target application and necessary configuration parameters to be used by a TN3270 client to access it. In one embodiment of the present invention, the session configuration information is included in a session configuration file having a file extension that will invoke the SNA application navigator when received by the Web browser at the workstation. Once invoked, the SNA application navigator retrieves information associated with TN3270 clients installed on the workstation. With this retrieved information and the session configuration information, the SNA application navigator configures an appropriate TN3270 client and launches it thereby providing the user with access to the SNA target application.

### BACKGROUND

1. Field of the Invention

The present invention relates generally to computer software applications and more particularly to a system and method for automatically configuring and launching Telnet 3270 client applications in a Windows environment.

2. Discussion of the Related Art

System Network Architecture (“SNA”) is a proprietary IBM architecture and set of applications for network computing within an enterprise. SNA applications, or so-called “green screen” applications, are legacy applications developed for use across these enterprise networks. With the advent of multi-enterprise networks, the Internet, and TCP/IP protocols, a need existed for continuing to access these SNA applications across IP networks. Telnet 3270 technologies, including TN3270 and TN3270 Enhanced, were developed in response to this need. These technologies follow conventional client/server approaches. Examples of client side solutions that implement these technologies include “Host on Demand” from IBM and “WebClient” from OpenConnect. Examples of server side solutions that implement these technologies include “Network Utility” from IBM or Cisco router offerings.

A TN3270 client typically operates on a user's workstation while a TN3270 server is typically placed in front of or within the corresponding mainframe. Traditional IP protocols are used between the TN3270 client and the TN3270 server while SNA protocols are used between the TN3270 server and the SNA applications on the mainframes.

Further information regarding Telnet technologies, TN3270, TN3270 Enhanced, Network Utility and more generally, “SNA over IP” can be found in the following publications, which are incorporated herein by reference: “IBM 2216/Network Utility Host Channel Connection”, Erol Lengerli, Jacinta Carbonell, Thomas Grueter; IBM International Technical Support Organization, January 1999, SG24-5303-00; “IBM Network Utility Description and Configuration Scenarios”, Tim Kearby, Peter Gayek, Gallus Schlegel, Imre Szabo, Zhi-Yong Zhang; IBM International Technical Support Organization, January 1999, SG24-5289-00; “Internetworking with TCP/IP—Volume I—Principles, Protocols, and Architecture” Douglas E. Comer, Second Edition, Prentice Hall 1991; “SNA and TCP/IP Integration”, Jerzy Buczak, Karl Wozabal, Antonio Luca Castrichella, Heikki Lehikoinen, Maria Cristina Madureira, Tsutomu Masaoka, IBM International Technical Support Organization, April 1999, SG24-5291-00; “TCP/IP Tutorial and Technical Overview”, Martin W. Murhammer, Orcun Atakan, Stefan Bretz, Larry R. Pugh, Kazunari Suzuki, David H. Wood, IBM International Technical Support Organization, October 1998, GG24-3376-05; and Request For Comments (RFCs) from the Internet Engineering Task Force (IETF) including: RFC 1576: TN3270 Current Practices, RFC 1646: TN3270 Extensions for LU name and Printer Selection, RFC 1647: TN3270 Enhancements, RFC 2355: TN3270 Enhancements.

One problem associated with Windows applications, in general, is that they can be installed at the user's (or system administrator's) discretion at very different locations (e.g., disks, etc.) within the workstation. As a consequence, TN3270 clients can be locally installed at any disk location in every workstation, making an automatic triggering from a Web-based SNA application via a web browser a non standard operation as all possibilities for installation must be considered for all workstations. While web browsers typically make use of Windows associations for triggering Web-based applications from within the web browser, TN3270 clients do not use or provide such capabilities.

Another problem is that a large number of TN3270 clients are available. TN3270 clients range from freeware products to commercial products. Each of these products has its own peculiarities and more importantly, its own set(s) of interfaces and conventions for configuring and launching the TN3270 client. Furthermore, TN3270 clients exist in two families. The first family of TN3270 clients requires that each and every configuration parameter be specified within a specific configuration file at an installation specific location. The second family of TN3270 clients allows for some configuration parameters to be passed as run time parameters when the TN3270 client is launched. However, neither family of TN3270 clients uses any sort of standard set of configuration parameters or mechanism for specifying them.

These and other problems are associated with TN3270 clients. What is needed is an improved system and method for automatically configuring and launching TN3270 client applications in a Windows environment.

### SUMMARY OF THE INVENTION

The present invention provides a system and method for automatically configuring and launching Telnet “TN” 3270 clients in a Windows environment. In one embodiment of the present invention, a user, operating on his workstation, selects an SNA target application from a remote location that hosts a Web application navigator. The user accomplishes this via a standard web browser, such as Netscape Navigator or Microsoft Internet Explorer, operating on the workstation. Workstation 120 subsequently receives a session configuration file sent by the Web application navigator based on the selected SNA target application. The web browser invokes a SNA application navigator by recognizing the session configuration file as having a file extension associated with the SNA application navigator. The SNA application navigator retrieves a workstation configuration file previously stored on the workstation. The workstation configuration file includes information regarding various TN3270 clients that are installed on the workstation, including information regarding their location, configuration parameters, etc.

The SNA application navigator then configures an appropriate TN3270 client based on the workstation configuration file and the session configuration file. The session configuration file includes information regarding which particular TN3270 client is to be used by the workstation for the selected SNA target application and which TN3270 server is to be used to access the SNA target application. After configuring the appropriate TN3270 client, the SNA application navigator launches it thereby providing the user with access to the SNA target application.

This and other aspects of the present invention will become apparent from the following drawings and description.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates an environment in which various embodiments of the present invention operate.

FIG. 2 illustrates one embodiment of the present invention.

FIG. 3 illustrates an operation of the present invention.

### DETAILED DESCRIPTION

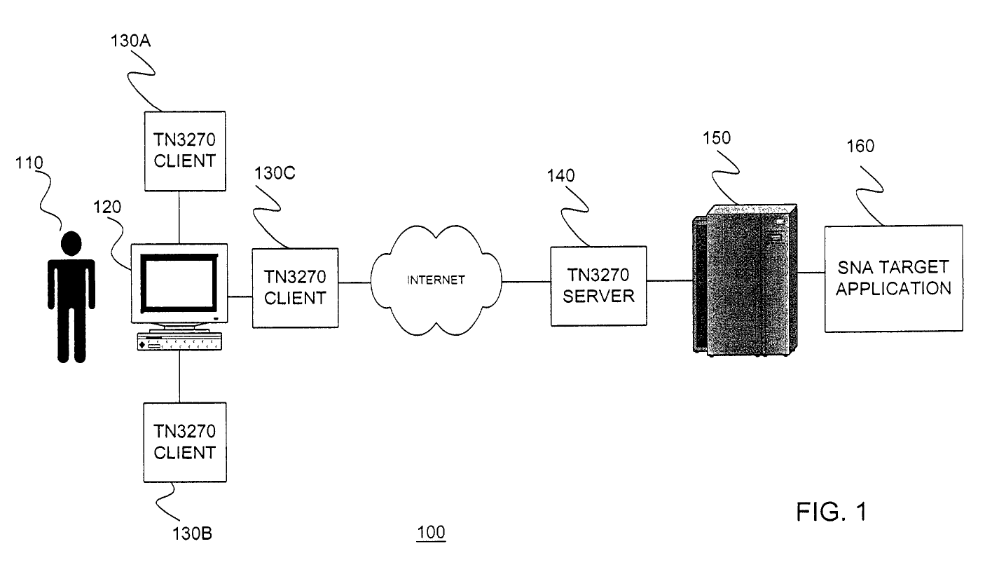

The present invention provides a system and method for automatically configuring and launching a Telnet 3270 client in a Windows environment. FIG. 1 illustrates an environment 100 in which various embodiments of the present invention operate including a workstation 120, one or more TN3270 clients 130 (illustrated as a TN3270 client 130A, a TN3270 client 130B, and a TN3270 client 130C) installed on workstation 120, and a corresponding TN3270 server 140 interfaced to or operating on a mainframe 150. The TN3270 client 130 and the TN3270 server 140 are coupled with one another via various IP protocols over a network. The mainframe 150 hosts an SNA target application 160.

In a conventional manner, in order to access the SNA target application 160, a user 110 identifies and locates an appropriate one of the TN3270 clients 130 currently installed in the workstation (illustrated as TN3270 client 130C in this example) and configures it to operate with the TN3270 server 140. This is a non-trivial process as user 110 must know which TN3270 server 140 is associated with the SNA target application 160, where that TN3270 server is located (in terms of an IP address, a DNS name, etc.), and what parameters are required for the TN3270 client 130C and TN3270 server 140 to provide the desired access to the SNA target application 160. In this example, user 110 selects and launches the TN3270 client 130C. This may include providing the TN3270 client 130C with some configuration parameters to properly connect to the TN3270 server 140 via IP protocols over the network. In this manner, the user 110 gains access to the SNA target application 160. This process is generally well known.

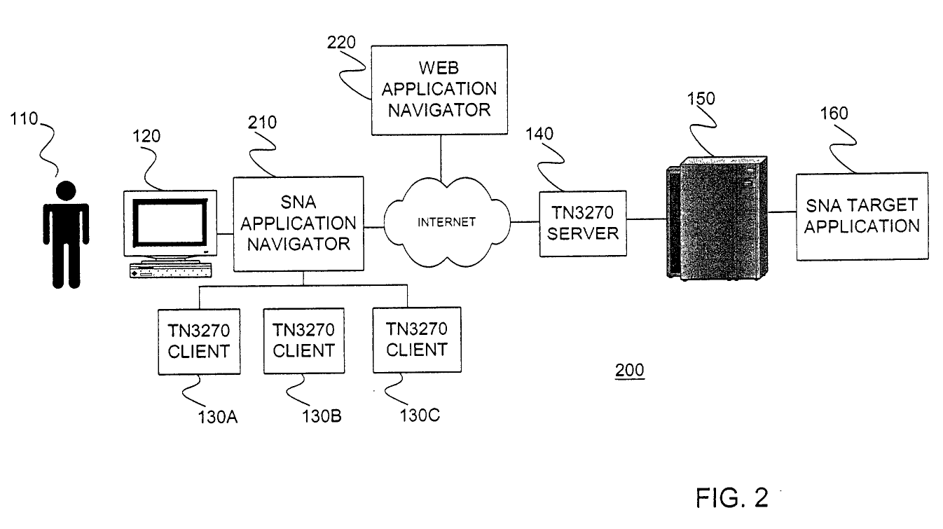

FIG. 2 illustrates an environment 200 in which an embodiment of the present invention operates including an SNA application navigator 210 and a Web application navigator 220 as well as various elements included in environment 100. According to the present invention, the SNA application navigator 210 operates on the workstation 120 and in conjunction with the Web application navigator 220 to access the SNA target application 160. In one embodiment of the present invention, the SNA application navigator 210 also operates in conjunction with a web browser installed on the workstation 120 (not otherwise illustrated) to remotely access the Web application navigator 220 via the network. In other embodiments of the present invention, the SNA application navigator 210 and the Web application navigator 220 are co-located on the workstation 120. The operation of this later embodiment will become apparent from the description of the embodiment illustrated in FIG. 2.

In one embodiment of the present invention, the user 110 accesses the Web application navigator 220 through the web browser when access to the SNA target application 160 is desired. The Web application navigator 220 provides the user 110 with indicia that identify the various SNA target applications 160 that are accessible by user 110. The indicia may be provided as a menu, a collection of icons, a set of hyperlinks, etc., as would be apparent. The indicia may be provided for all the possible SNA target applications 160 in the network, or only for those that the user 110 is permitted to access (erg., as determined by a network administrator, etc.) or for those SNA target applications 160 that the Web application navigator 220 knows are available (up and running).

In one embodiment, the user 110 selects one of the listed SNA target applications 160 from the indicia provided by the Web application navigator 220, for example, via a “mouse click.” Other mechanisms for selecting one of the SNA target applications 160 are available as would be apparent. After the user 110 selects one of the SNA target applications 160, the Web application navigator 220 provides the SNA application navigator 210 with information associated with the appropriate TN3270 client 130 to be installed and/or configured on workstation 120 to access the selected SNA target application 160. In some embodiments of the present invention, the Web application navigator 220 provides the SNA application navigator 210 with an entire TN3270 client 130. In other embodiments of the present invention, the Web application navigator 220 provides the SNA application navigator 210 with information that identifies the appropriate TN3270 client 130 to use for the selected SNA target application. In other embodiments, where no TN3270 client 130 is specified, a default TN3270 client 130 may be used. In each of these embodiments, the configuration parameters required for the selected TN3270 client 130 are provided.

In addition to the information associated with the appropriate TN3270 client 130, the Web navigator 170 also provides the SNA application navigator 210 with information that identifies an appropriate TN3270 server 140 associated with the selected SNA target application 160. This information may include an IP address, a DNS name, or other information that identifies the appropriate TN3270 server 140 as would be apparent. Other information may be provided as would be apparent.

According to the present invention, the Web application navigator 220 and the SNA application navigator 210 operate in conjunction with one another to: 1) understand the configuration of workstation 120, including the location of all possible TN3270 clients 130 installed thereon; 2) understand how these TN3270 clients 130 have been installed, how they are to be configured and/or launched once user 110 has selected one of the SNA target applications 160; and 3) understand which TN3270 server 140 is required, where it is located.

Once the appropriate TN3270 server 140 is identified, the SNA application navigator 210 launches the TN3270 client 130 thereby initiating the session with the SNA target application 160 on the mainframe 160.

In one embodiment of the present invention, the aforementioned configuration information is provided to the SNA application navigator 210 by the Web application navigator 220 in a session configuration file. More specifically, the Web application navigator 220 provides the session configuration file to a web browser on workstation 120 that recognizes the session configuration file as one associated with the SNA application navigator 210. Thus, when the session configuration file is received, the web browser automatically invokes the SNA application navigator 210 to process it. The operation of the Web application navigator 220 and the SNA application navigator 210 is described in further detail below.

In one embodiment of the present invention, the SNA application navigator 210 includes two modes of operation: an initialization mode, and an execution mode. The initialization mode is now described. In order to access the SNA applications 160 via the Web application navigator 220 for the first time, the SNA application navigator 210 must be first installed on the workstation 120. In one embodiment of the present invention, the SNA application navigator 210 is downloaded to and installed on the workstation 120 when the user 110 accesses the Web application navigator 220 for the first time. This may be accomplished automatically, as would be apparent, or upon the user 110 selecting a “download” or “install” hyperlink from an interface provided by the Web application navigator 220 as would also be apparent.

Once downloaded and installed, the SNA application navigator 210 is launched either automatically or upon being selected by the user 110. In one embodiment, when launched, if the SNA application navigator 210 detects no configuration information on the workstation 120, it enters the initialization mode.

During the initialization mode, SNA application navigator 210 attempts to gather information about the workstation 120 including which of various web browsers will be used and which of various TN3270 clients 130 may be used. In one embodiment of the present invention, SNA application navigator 210 presents to the user 110 an initialization panel that allows the user 110 to specify this information. The initialization panel may present the user 110 with a list of web browsers that are supported, for example, Internet Explorer, Netscape Navigator, etc. The user 110 may then select which one(s) he will potentially use. Once selected, SNA application navigator 210 performs an association (within the context of the selected web browser(s)) between itself and files having a particular file extension (e.g., “.abc”). After the association is made, when files of this particular extension are accessed and downloaded via the web browser, the SNA application navigator 210 is invoked by the web browser to process the files as would be apparent. In some embodiments of the present invention, this is done with no intervention required by the user 110 to accept or reject the download as the user 110 is able to configure his web browser to always accept the downloading of such files.

The initialization panel may also present the user 110 with a list of available TN3270 clients 130 that may be used within the workstation 120. In one embodiment of the present invention, a list of supported TN3270 clients 130 is presented, from which the user 110 can select ones he will potentially use. In one embodiment of the present invention, for each of the selected TN3270 clients 130, the user 110 may be asked to identify the directory within the workstation 120 where the TN3270 client 130 is located. In another embodiment of the present invention, locating the directory of the TN3270 client 130 may be automated as would be apparent.

For example, the user 110 may specify that he will use a particular TN3270 client 130 such as “Personal Communication (Pcomm),” and that this particular TN3270 client 130 is located in the ”c:\Program_Files\Personal_Communications\” installation directory. In one embodiment of the present invention, this also implicitly means that initialization file for this particular TN3270 client 130 is located in the “\Private\” subdirectory of the installation directory.

In other embodiments of the present invention, the web browser information and/or the TN3270 client 130 information is gathered automatically using various Windows facilities as would be apparent. In one embodiment of the present invention, this information is stored on the workstation 120 in a workstation configuration file.

In one embodiment of the present invention, the user 110 may specify a default TN3270 client 130. This may be useful, for example, when several TN3270 clients 130 are installed in the workstation, and the default TN3270 client 130 is the one preferred by the user 110.

In some embodiments of the present invention, the initialization panel may provide a list to the user 110 of URLs to sites where various TN3270 clients 130 may be downloaded. The user 110 may then decide to download and install various TN3270 clients 130 as would be apparent.

As would also be apparent, the user 110 may restart the SNA application navigator 210 to reinstall various TN3270 clients 130, add a new TN3270 client, recover from a problem, etc.

In any case, the information that is gathered by the SNA application navigator 210 during the initialization mode is saved within the workstation 120 in the workstation configuration file. In some embodiments of the present invention where the workstation 120 is always loaded and configured the same way, for example, within a particular company, a pre-built workstation configuration file could be preloaded onto the workstation.

With a single workstation configuration file across all users within a company, embodiments of the present invention avoid the need for specific configuration files for the Web application navigator 220. This results in a highly scalable and secure solution over applications that require a dedicated configuration file per workstation and/or type of TN3270 client. In addition, problem determination as well as maintenance are greatly simplified.

Having thus described the initialization mode, the execution mode is now described. When the Web application navigator 220 is subsequently accessed by the user 110 through the web browser, the Web application navigator 220 provides the user 110 with indicia of the potential SNA target applications 160 as discussed above. When the user 110 selects one of the SNA target applications by, for example, clicking on a hyperlink within a selection screen, a session configuration file is returned across the network to the workstation 120. In one embodiment, this session configuration file has an extension that identifies it as one associated with the SNA application navigator 210 thereby causing the web browser to invoke the SNA application navigator 210.

In some embodiments of the present invention, this session configuration file includes identifying information (e.g., an IP address, a DNS name, etc.) of one of the TN3270 servers 140 to use to access the selected SNA target application 160. In some embodiments of the present invention, this file may also include identifying information of one of the TN3270 clients 130 to use for the session. In some embodiments of the present invention, if no TN3270 client 130 is specified, the default TN3270 client 130 may be used. This file may also include various configuration parameters to be used during the session. This file is dynamically built by the Web application navigator 220, based on configuration information provided to the Web application navigator 220 by a network operator.

In some embodiments of the present invention, only the configuration information (i.e., TN3270 client parameters) obtained from the Web application navigator 220 is updated by the SNA application navigator 210. In other words, other TN 3270 client parameters not specified by the Web application navigator 220 (such as the sizes of the screens for example) are left unchanged by the SNA application navigator.

With the session configuration file and the workstation configuration file stored during initialization, the SNA application navigator 210 knows the location of the TN3270 client 130 to launch, how to configure that TN3270 client 130, if necessary, either prior to or during execution via run-time parameters, and with which TN3270 server 140 it should initiate a session in order to access the selected SNA target application 160. Once completed, the SNA application navigator 210 stops its own execution.

The actual configuring and launching of the various TN3270 clients 130 are generally well known. In one embodiment of the present invention, the SNA application navigator 210 is provided with a workstation configuration file for each TN3270 client 130 installed on the workstation 120. In an alternate embodiment, the SNA application navigator 210 is provided with a single workstation configuration file that includes information for all installed TN3270 clients 130. In either embodiment, these workstation configuration files may also include all possible initialization keywords along with their use for the respective TN3270 client 130.

Following the previously described “Pcomm” example, in some embodiments of the present invention, the SNA application navigator 210, knowing from the “.abc” file that PComm should be used, will access the Pcomm initialization file located in the “c:\Program_Files\Personal_Communications\Private\” directory within the workstation 120, will locate a “HostName=xxxxxx” statement, will replace the “xxxxxx” with the address of the appropriate TN3270 server 140 (i.e., the IP address or DNS name) from the “.abc” file, and finally will save the configuration file at the same location. Then, after starting PComm, the SNA application navigator 210 stops its own execution. PComm is automatically directed to use the appropriate TN3270 server 140 by the appropriately modified Pcomm initialization file.

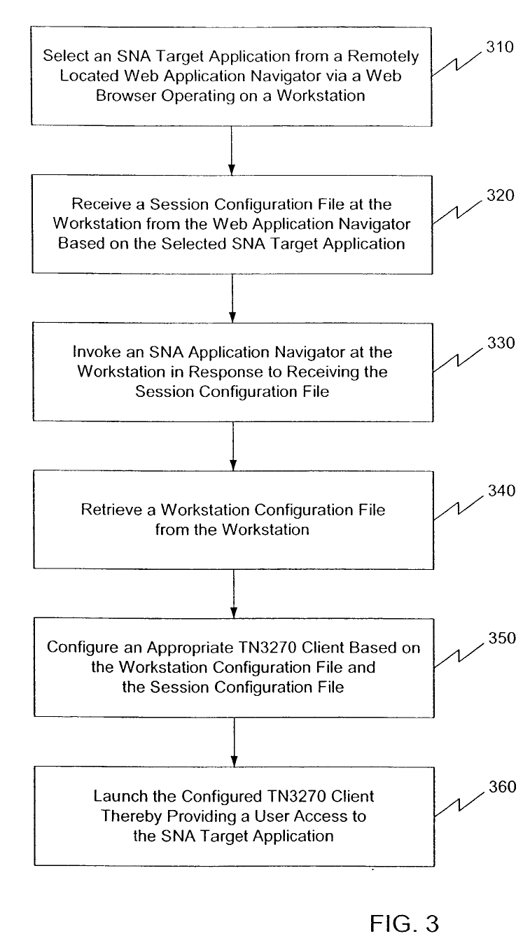

FIG. 3 illustrates an operation of one embodiment of the present invention in further detail. In an operation 310, a user 110, operating on workstation 120 selects an SNA target application 160 from a remote location (i.e., a web site) that hosts the Web application navigator 220 via a web browser operating on the workstation 120. In response, in an operation 320, the workstation 120 receives a session configuration file sent by the Web application navigator 220 based on the selected SNA target application 160.

In an operation 330, the web browser operating on the workstation 120 invokes the SNA application navigator 210 by recognizing the session configuration file as having a file extension associated with the SNA application navigator 210.

In an operation 340, the SNA application navigator 210 retrieves a workstation configuration file from the workstation 120. In an operation 350, the SNA application navigator 210 configures an appropriate TN3270 client 130 based on the workstation configuration file and the session configuration file. In an operation 360, the SNA application navigator 210 launches the configured TN3270 client 130 thereby providing the user 110 with access to the SNA target application 160.

Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

The previous description of the preferred embodiments is provided to enable any person skilled in the art to make or use the present invention. While the invention has been particularly shown and described with reference to preferred embodiments thereof, it will be understood by those skilled in the art that various changes in form and details may be made therein without departing from the spirit and scope of the invention.

What is claimed is:

1. A method for automatically configuring and launching a TN3270 client comprising:
gathering configuration information associated with each of a plurality of TN3270 clients installed on a workstation, said configuration information including at least an identity and a location associated with each of said plurality of TN3270 clients;
in response to a user designating a desired SNA target application, receiving session configuration information including at least information identifying a TN3270 client to launch to access said SNA target application and information identifying a TN3270 server to which said TN3270 client should interface; and
in response to receiving said session configuration information, automatically configuring said TN3270 client for interfacing with said TN3270 server and automatically launching said configured TN3270, thereby providing the user access to said desired SNA target application.

2. The method of claim 1, further comprising receiving indicia identifying at least one SNA target application.

3. The method of claim 2, wherein said receiving indicia identifying at least one SNA target application comprises receiving said indicia via a web browser from a location remote from the workstation.

4. The method of claim 1, wherein said receiving session configuration information comprises receiving said session configuration information through a web browser operating on the workstation.

5. The method of claim 4, wherein said receiving session configuration information comprises receiving said session configuration information through a web browser operating on the workstation.

6. The method of claim 4, wherein said receiving said session configuration information comprises receiving a session configuration file through a web browser operating on the workstation.

7. The method of claim 6, wherein said receiving a session configuration file comprises receiving a session configuration file having a file extension recognized by the web browser which thereby initiates said automatically configuring and said automatically launching.

8. An article of manufacture, which comprises a computer readable medium having stored therein a computer program carrying out a method for automatically configuring and launching a TN3270 client, the computer program comprising:
a first code segment for gathering configuration information associated with each of a plurality of TN3270 clients installed on a workstation, said configuration information including at least an identity and a location associated with each of said plurality of TN3270 clients;
a second code segment for receiving session configuration information including at least information identifying a TN3270 client to launch to access said SNA target application and information identifying a TN3270 server to which said TN3270 client should interface; and
a third code segment for automatically configuring said TN3270 client for interfacing with said TN3270 server;
a fourth code segment for automatically launching said configured TN3270, thereby providing the user access to said desired SNA target application.

9. A system for automatically configuring and launching a TN3270 client comprising:
a workstation;
a web browser operable on said workstation;
an SNA application navigator operable to gather configuration information associated with a TN3270 client installed on said workstation, to receive session configuration information from a remote location via said web browser, to configure said TN3270 client in accordance with said configuration information and said session configuration information, and to launch said TN3270 client.

10. A method for accessing a remote SNA target application from a workstation comprising:
selecting an SNA target application to access from a Web application navigator, the Web application navigator located remotely from the workstation;
receiving a session configuration file from the Web application navigator based on the selected SNA target application;
invoking a SNA application navigator in response to said receiving the session configuration file;
retrieving a workstation configuration file the workstation; configuring an appropriate TN3270 client based on the workstation configuration file and the session configuration file; and
launching the appropriate TN3270 client thereby providing the user with access to the SNA target application.

11. The method of claim 10, wherein said selecting an SNA target application and said receiving a session configuration file are accomplished via a web browser operating on the workstation.

12. The method of claim 10, wherein said invoking an SNA application navigator is accomplished via an association made between a file extension of the session configuration file and the SNA application navigator.
